(19) United States
(12) Patent Application Publication
(10) Pub. No.: US 2020/0268492 A1
(43) Pub. Date: Aug. 27, 2020

(54) EASY-TO-OPERATE ORAL IRRIGATOR

(71) Applicant: Shenzhen Flycat Electrical Co., Ltd., Shenzhen (CN)

(72) Inventors: Jinfeng LI, Shenzhen (CN); Gang WANG, Shenzhen (CN); Qing ZHANG, Shenzhen (CN); Xinquan LIU, Shenzhen (CN); Xiaowen LIU, Shenzhen (CN)

(21) Appl. No.: 16/283,500

(22) Filed: Feb. 22, 2019

(51) Int. Cl. A61C 17/028; A61C 17/02

(52) U.S. Cl. CPC A61C 17/028; A61C 17/0205; A61C 17/0202

(57) ABSTRACT

The disclosure provides an easy-to-operate oral irrigator, which belongs to the field of oral cleaning and nursing. The oral irrigator comprises a water tank, a body, a power device, a control board, a nozzle, and a handle assembly, wherein the power device and the control board are disposed inside the body, the water tank and the handle assembly are disposed on the body, the body is further provided with a switch knob connected to the control board, the handle assembly is connected to the power device through a drain pipe, the nozzle is connected to the handle assembly, and the power device is used to deliver water in the water tank to the handle assembly through the drain pipe and spray it through the nozzle.

### TECHNICAL FIELD

The present disclosure relates to the field of oral cleaning and nursing, in particular to an easy-to-operate oral irrigator.

### TECHNICAL BACKGROUND

Oral or dental irrigators are a relatively new type of oral cleaning devices. In Europe and the United States, the oral irrigators are an essential hygiene item for many households. Nowadays, the oral or dental irrigatorshave entered China, and many people have gradually liked this kind of comfortable and useful dental oral hygiene products. However, a nozzle in the existing oral irrigator is directly mounted on a body or a water tank, and when used, the operation is very inconvenient.

The existing oral irrigators are generally provided with multiple gear positions, it is impossible to select any one of the pressure points in the range, the inlet water flow rate cannot be adjusted, and only the outlet flow rate is set through the nozzle, while the noise is very large. The existing oral irrigators do not have a pause function during operation unless a switch is turned off.

### SUMMARY

In order to solve the problems in the prior art, the present disclosure provides an easy-to-operate oral irrigator.

The disclosure comprises a water tank, a body, a power device, a control board, a nozzle, and a handle assembly, wherein the power device and the control board are disposed inside the body, the water tank and the handle assembly are disposed on the body, the body is further provided with a switch knob connected to the control board, the handle assembly is connected to the power device through a drain pipe, the nozzle is connected to the handle assembly, and the power device is used to deliver water in the water tank to the handle assembly through the drain pipe and spray it through the nozzle.

As a further improvement of the disclosure, the water tank is in communication with the body through an anti-leak valve, the power device comprises a direct current motor, a gear assembly, a linkage, a piston and a pump body, the direct current motor is connected to the gear assembly, one end of the linkage is connected to the gear assembly, and the other end is connected to the piston, the piston is disposed on the pump body, and moves relative to the pump body under the action of the linkage, a pump inlet and a water outlet are also disposed on the pump body, and the pump inlet is connected to the water tank through a pipe socket, and the water outlet is connected to the drain pipe through a water outlet pipe clamp.

As a further improvement of the disclosure, the direct current motor is a pulse motor, the control board controls pulse frequency, a circuit uses a direct current low voltage, and an operating voltage is 12V.

As a further improvement of the disclosure, the handle assembly is detachably disposed on the body by a handle bracket, the handle assembly comprises a handle housing and a handle valve body disposed in the handle housing, a water inlet of the handle valve body is connected to the drain pipe, a nozzle holder is connected to a water outlet of the handle valve body, a nozzle knob is fixed on the nozzle holder, and the nozzle is disposed on the nozzle knob through the nozzle holder.

As a further improvement of the disclosure, a sealing ring is disposed between the handle valve body and the nozzle holder, and a knob spring is disposed between the nozzle holder and the nozzle knob.

As a further improvement of the disclosure, the handle housing is further provided with a push-slide assembly therein for suspending the spray of water from the nozzle, the push-slide assembly comprising a push-slide button, a push slider, a push-slide spring, and a sealing plug, wherein the handle housing is provided with a through hole for receiving the push-slide button, the back of the push-slide button is connected to the push slider, the push slider is sleeved with a push-slide spring at the other end, and is connected to the sealing plug, the sealing plug is capable of blocking a through hole for water flow in the handle valve body, and a double-layer waterproof O-shaped sealing ring is disposed between the push slider and the handle valve body.

As a further improvement of the disclosure, the switch knob is disposed on a side of the body, a front side of the body is provided with a water pipe storage box and a handle bracket, and the water pipe storage box is disposed below the handle bracket. The handle position is designed on the front side of the body for easy access and space reduction.

As a further improvement of the disclosure, the top of the water tank is provided with a water tank upper cover and a water tank lower cover, the water tank lower cover is connected to the water tank, the water tank lower cover is hinged with the water tank upper cover, and the water tank lower cover and the water tank upper cover are combined to form a storage box, which can easily store components of the oral irrigator.

As a further improvement of the disclosure, a plurality of nozzle storage passages is provided in the storage box.

As a further improvement of the disclosure, the large body is provided with a waterproof ring groove assembled with a waterproof ring, which is located between a decorative ring and the large body, and when the decorative ring and the sleeve are assembled, the waterproof ring is closely attached to the large body and the decorative ring, achieving the waterproof effect.

As a further improvement of the disclosure, a base is disposed below the body, a plurality of supporting legs is disposed on a lower surface of the base, the power device and the control board are fixed on the base through a bracket, and a plurality of anti-vibration glues is disposed between the base and the bracket.

Compared with the prior art, the disclosure provides the beneficial effects that the length of the drain pipe can be adjusted through the detachable handle assembly and the drain pipe connected to the handle assembly, thereby adapting to different distances, and it is very convenient to use; the switch is integrated, the voltage regulation is stepless, and within a certain range, any pressure point can be selected through the switch knob; the water pressure is pulsed, and the pulse frequency of the oral irrigator can be adjusted within the range of 1320-1500 times/minute, while the inlet flow rate can also be adjusted and the noise is low; and the slide type of switch on the handle can be instantly switched off.

### BRIEF DESCRIPTION OF THE DRAWINGS

FIG. 1 is a schematic view showing an exploded structure of a water tank of the disclosure;

FIG. 2 is a schematic view showing an exploded structure of a body housing of the disclosure;

FIG. 3 is a schematic view of an exploded structure of a handle assembly; and

FIG. 4 is a schematic view showing an exploded structure of the interior of the body of the utility mode.

### REFERENCE NUMBERS

01—water tank upper cover;

02—water tank lower cover;

03—anti-leak valve;

04—water tank;

05—handle bracket;

06—first self-tapping screw;

07—body;

08—knob decorative ring;

09—switch knob;

10—knob waterproof ring;

11—direction current motor;

12—fire cow (transformer) shell;

13—gear box;

14—tooth screw;

15—linkage;

16—motor gear;

17—drive gear;

18—gear shaft;

19—bracket;

20—anti-vibration glue;

21—tube frame;

22—base;

23—adhesive foot;

24—second self-tapping screw;

25—pressure line code;

26—power supply line;

27—PCBA control board;

28—outlet pipe bracket;

29—outlet pipe clamp;

30—first sealing ring;

31—valve clack;

32—third self-tapping screw;

33—pump body;

34—plug;

35—piston;

36—valve piston;

37—stainless steel ball;

38—valve spring;

39—water pump sealing ring;

40—valve piston plug;

41—sealing cap;

42—second sealing ring;

43—pump inlet;

44—fourth self-tapping screw;

45—pipe holder;

46—nozzle ring;

47—nozzle;

48—nozzle knob;

49—knob spring;

50—nozzle holder;

51—back handle housing;

52—U-shaped sealing ring;

53—nozzle snap spring;

54—nozzle snap button;

55—handle valve body;

56—sealing plug;

57—O-shaped seal ring;

58—push-slide spring;

59—push slider;

60—front handle housing;

61—push-slide button;

62—drain pipe; and

63—nozzle assembly.

### DETAILED DESCRIPTION

The disclosure will be further described in detail below with reference to the accompanying drawings and embodiments.

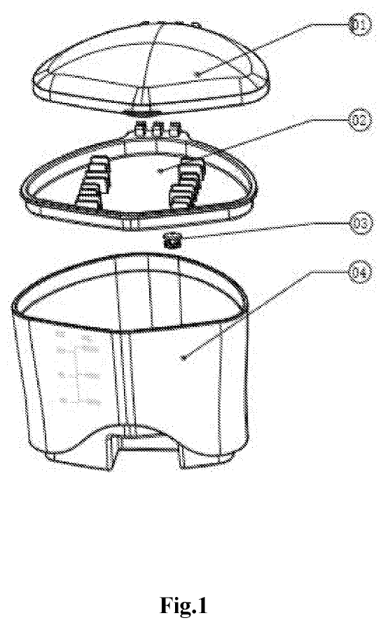

As shown in FIG. 1 to FIG. 4, the disclosure comprises a water tank 04, a body 07, a power device, a PCBA control board 27, a nozzle 47, and a handle assembly, wherein the power device and the PCBA control board 27 are disposed inside the body 07, the water tank 04 and the handle assembly are disposed on the body 07, the body 07 is further provided with a switch knob 09 connected to the PCBA control board 27, the handle assembly is connected to the power device through a drain pipe 62, the nozzle 47 is connected to the handle assembly, and the power device is used to deliver water in the water tank 04 to the handle assembly through the drain pipe 62 and spray it through the nozzle 47. In this example, the water tank 04 is connected to the body 07 through an anti-leak valve 03.

As shown in FIG. 1, in this example, the top of the water tank 04 is provided with a water tank upper cover 01 and a water tank lower cover 02. The water tank lower cover 02 is connected to the water tank 04, and the water tank lower cover 02 is hinged with the water tank upper cover 01 by a connecting shaft, the water tank lower cover 02 and the water tank upper cover 01 are combined to form a storage box, which can conveniently store the components of the oral irrigator. The water tank upper cover 01 and the water tank lower cover 02 of this example adopt a shell-like design. The top cover of the storage box can be detached, and multiple nozzles can be stored therein for easy replacement. There are 4 nozzle storage passages in the storage box of this example, and 4 nozzles can be placed concurrently. There are a variety of nozzles with replacable functions to meet various groups of people. In this example, a transparent water tank is used, the water volume is 0-600 ML with scaling, and the amount of water used is known at a glance.

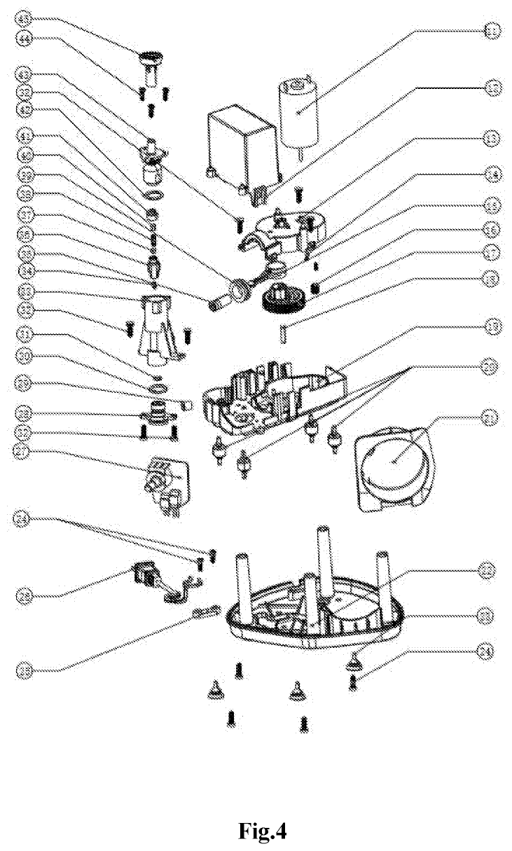

As shown in FIG. 4, a base 22 is disposed below the body 07, and four supporting legs 23 are fixed on the lower surface of the base 22. The power device and the PCBA control board 27 are fixed on the base 22 by nuts on the PCBA control board 27 assembly, respectively. Four anti-vibration glues 20 are disposed between the base 22 and the bracket 19, The supporting legs 24 and the anti-vibration glues 20 are arranged so that the fixability of the entire oral irrigator is better and the anti-collision and anti-push performance is more stable.

The power device of this example includes a direct current motor 11, a motor gear 16, a drive gear 17, a linkage 15, a piston 35, and a pump body 33 connected in sequence. The piston 35 is disposed on the pump body 33 and moves relative to the pump body 33 with the action of the linkage 15. The pump body 33 is further provided with a pump inlet 43 and a water outlet, the pump inlet 43 is connected to the water tank 04 through a pipe holder 45, and the water outlet is connected to the drain pipe 62 through the water outlet pipe clamp 29.

The operation mode of this example is as follows:

A power supply line 26 supplies 220V voltage, and then converts and outputs 12V AC (alternating current) safety voltage, so that the direct current motor 11 operates as power, converts the movement of the drive gear, causes a vacuum inside the pump body 33, and thus introduces the water in the water tank 04 into the body 07. By controlling the amount of compression of the internal vacuum, the pulsed water pressure is obtained, and the water generates different water columns through the nozzle 47, which plays a certain cleaning effect on the oral cleaning.

In this example, the direct current motor 11 uses a direct current pulse motor, and the pulse frequency is controlled through the chip of the PCBA control board 27 to realize water flow frequency conversion control. The motor does not generate heat and can be used continuously. At the same time, the internal circuit adopts direct current low voltage design, and the working voltage is 12V, which is a safe voltage below 36V, ensuring safe use of the electrical appliance in a multi-water environment around the bathroom washstand.

The switch knob 09 of this example is an integrated switch, the voltage regulation is stepless, and within a certain range, any one of the pressure points can be selected. And by pulsed water pressure, the pulse frequency of the oral irrigator can be adjusted within the range of 1320-1500 times/minute, and the inlet flow rate can also be adjusted. In general, the higher the vibration frequency is, the better the cleaning effect is.

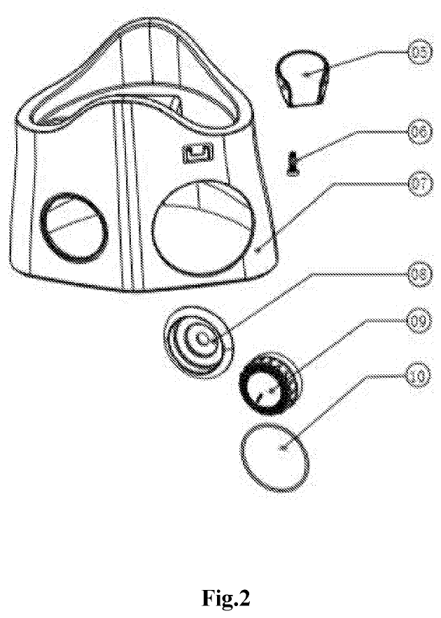

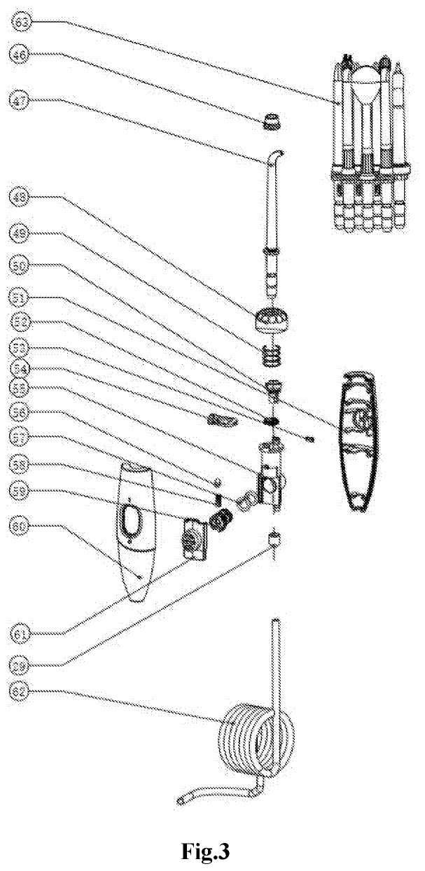

As shown in FIG. 2 and FIG. 3, the switch knob 09 is disposed on a side of the body 07, the front side of the body 07 is provided with a water pipe storage box for storing the drain pipe 62 and a handle bracket 05, and the water pipe storage box is disposed below the handle bracket 05. The handle position is designed on the front side of the body for easy access and space reduction. The drain pipe 62 of this example adopts a 1 meter retractable water pipe to meet various distance requirements and is convenient to store.

The handle assembly of this example is detachably disposed on the body 07 by a handle bracket 05, the handle assembly includes a front handle housing 60, a back handle housing 51 and a handle valve body 55 disposed in the handle housing, a water inlet of the handle valve body 55 is connected to the drain pipe 62, a nozzle holder 50 is connected to a water outlet of the handle valve body 55, a nozzle knob 48 is fixed on the nozzle holder 50, and the nozzle 47 is disposed on the nozzle knob 48 through the nozzle holder 50.

Further, a U-shaped sealing ring is disposed between the handle valve body 55 and the nozzle holder 50, and a knob spring 49 is disposed between the nozzle holder 50 and the nozzle knob 48.

In order to realize the pause function, the handle housing of this example is further provided with a push-slide assembly therein for suspending the spray of water from the nozzle 47. The push-slide assembly includes a push-slide button 61, a push slider 59, a push-slide spring 58, and a sealing plug 56. The handle housing is provided with a through hole for receiving the push-slide button 61. The back of the push-slide button 61 is connected to the push slider 59. The other end of the push slider 59 is sleeved with the push-slide spring 58, and is connected to the sealing plug 56 capable of blocking the through hole for water flow in the handle valve body 55. When operating, the push-slide button 61 is pressed by hand, thereby pushing the sealing plug 56 to block the through hole for water flow in the handle valve body 55. At this time, the water flow of the nozzle 47 is suspended; as the push-slide button 61 is released, the push-slide spring 58 is elastically restored, and the sealing plug 56 is pulled to move back and release the through hole for water flow, the nozzle 47 resumes the water spray. Further, a double-layer waterproof O-shaped sealing ring 57 is disposed between the push slider 59 and the handle valve body 55, and the waterproof effect is better when the push-slide is made, to prevent water seepage. The slide type of switch on the handle can be instantly switched off. In addition, the nozzle snap button 54 and the nozzle snap spring 53 are arranged in such a manner that a button operation effects automatically popped-up to replace the nozzle button, which is convenient and quick. The nozzle knob 48 allows the nozzle 47 to be rotated at any angle within 360 degrees, which is more convenient to use.

The disclosure is very convenient to use and the operation is very simple. The device according to the disclosure can effectively improve the health of the gums, and reduce gingivitis; remove the tongue coating, remove the bad smell of the mouth, and freshen the breath; remove the plaque which is difficult to reach by the common dental floss; solve the trouble of cleaning the oral cavity by the orthodontic person; prevent tooth decay, gingivitis, calculus, periodontitis; and massage and stimulate gums, improving blood circulation and inhibiting gum bleeding.

The embodiments described above are preferred embodiments of the disclosure, and are not intended to limit the scope of the disclosure. The scope of the disclosure is not limited to the specific embodiments, and equivalent variations made according to the disclosure are within the scope of protection of the disclosure.

What is claimed is:

1. An easy-to-operate oral irrigator comprising a water tank, a body, a power device, a control board, a nozzle, and a handle assembly, wherein the power device and the control board are disposed inside the body, the water tank and the handle assembly are disposed on the body, the body is further provided with a switch knob connected to the control board, the handle assembly is connected to the power device through a drain pipe, the nozzle is connected to the handle assembly, and the power device is used to deliver water in the water tank to the handle assembly through the drain pipe and spray it through the nozzle.

2. The oral irrigator according to claim 1, characterized in that the water tank is in communication with the body through an anti-leak valve, the power device comprises a direct current motor, a gear assembly, a linkage, a piston and a pump body, the direct current motor is connected to the gear assembly, one end of the linkage is connected to the gear assembly, and the other end is connected to the piston, the piston is disposed on the pump body, and moves relative to the pump body under the action of the linkage, a pump inlet and a water outlet are also disposed on the pump body, and the pump inlet is connected to the water tank through a pipe socket, and the water outlet is connected to the drain pipe through a water outlet pipe clamp.

3. The oral irrigator according to claim 2, characterized in that the direct current motor is a pulse motor, the control board controls pulse frequency, a circuit uses a direct current low voltage, and an operating voltage is 12V.

4. The oral irrigator according to claim 3, characterized in that the handle assembly is detachably disposed on the body by a handle bracket, the handle assembly comprises a handle housing and a handle valve body disposed in the handle housing, a water inlet of the handle valve body is connected to the drain pipe, a nozzle holder is connected to a water outlet of the handle valve body, a nozzle knob is fixed on the nozzle holder, and the nozzle is disposed on the nozzle knob through the nozzle holder.

5. The oral irrigator according to claim 4, characterized in that a sealing ring is disposed between the handle valve body and the nozzle holder, and a knob spring is disposed between the nozzle holder and the nozzle knob.

6. The oral irrigator according to claim 5, characterized in that the handle housing is further provided with a push-slide assembly therein for suspending the spray of water from the nozzle, the push-slide assembly comprising a push-slide button, a push slider, a push-slide spring, and a sealing plug, wherein the handle housing is provided with a through hole for receiving the push-slide button, the back of the push-slide button is connected to the push slider, the push slider is sleeved with a push-slide spring at the other end, and is connected to the sealing plug, the sealing plug is capable of blocking a through hole for water flow in the handle valve body, and a double-layer waterproof O-shaped sealing ring is disposed between the push slider and the handle valve body.

7. The oral irrigator according to claim 4, characterized in that the switch knob is disposed on a side of the body, a front side of the body is provided with a water pipe storage box and the handle bracket, and the water pipe storage box is disposed below the handle bracket.

8. The oral irrigator according to claim 3, characterized in that the top of the water tank is provided with a water tank upper cover and a water tank lower cover, the water tank lower cover is connected to the water tank, the water tank lower cover is hinged with the water tank upper cover, and the water tank lower cover and the water tank upper cover are combined to form a storage box.

9. The oral irrigator according to claim 8, characterized in that a plurality of nozzle storage passages is provided in the storage box.

10. The oral irrigator according to claim 3, characterized in that a base is disposed below the body, a plurality of supporting legs is disposed on a lower surface of the base, the power device and the control board is fixed on the base through a bracket, and a plurality of anti-vibration glues is disposed between the base and the bracket.

11. The oral irrigator according to claim 2, characterized in that the handle assembly is detachably disposed on the body by a handle bracket, the handle assembly comprises a handle housing and a handle valve body disposed in the handle housing, a water inlet of the handle valve body is connected to the drain pipe, a nozzle holder is connected to a water outlet of the handle valve body, a nozzle knob is fixed on the nozzle holder, and the nozzle is disposed on the nozzle knob through the nozzle holder.

12. The oral irrigator according to claim 2, characterized in that the top of the water tank is provided with a water tank upper cover and a water tank lower cover, the water tank lower cover is connected to the water tank, the water tank lower cover is hinged with the water tank upper cover, and the water tank lower cover and the water tank upper cover are combined to form a storage box.

13. The oral irrigator according to claim 2, characterized in that a base is disposed below the body, a plurality of supporting legs is disposed on a lower surface of the base, the power device and the control board is fixed on the base through a bracket, and a plurality of anti-vibration glues is disposed between the base and the bracket.

14. The oral irrigator according to claim 1, characterized in that the handle assembly is detachably disposed on the body by a handle bracket, the handle assembly comprises a handle housing and a handle valve body disposed in the handle housing, a water inlet of the handle valve body is connected to the drain pipe, a nozzle holder is connected to a water outlet of the handle valve body, a nozzle knob is fixed on the nozzle holder, and the nozzle is disposed on the nozzle knob through the nozzle holder.

15. The oral irrigator according to claim 1, characterized in that the top of the water tank is provided with a water tank upper cover and a water tank lower cover, the water tank lower cover is connected to the water tank, the water tank lower cover is hinged with the water tank upper cover, and the water tank lower cover and the water tank upper cover are combined to form a storage box.

16. The oral irrigator according to claim 1, characterized in that a base is disposed below the body, a plurality of supporting legs is disposed on a lower surface of the base, the power device and the control board is fixed on the base through a bracket, and a plurality of anti-vibration glues is disposed between the base and the bracket.
